(19) United States
(12) Patent Application Publication
(10) Pub. No.: US 2026/0158805 A1
(43) Pub. Date: Jun. 11, 2026

(54) IMAGE FORMING APPARATUS

(71) Applicant: KYOCERA DOCUMENT SOLUTIONS INC., OSAKA (JP)

(72) Inventors: TAKAHITO MORITA, Osaka (JP); HIROAKI TAKAI, Osaka (JP)

(21) Appl. No.: 19/412,877

(22) Filed: Dec. 9, 2025

(30) Foreign Application Priority Data
Dec. 11, 2024 (JP) 2024-216299

(51) Int. Cl. B41J 13/28; B41J 13/00; B41J 13/03

(52) U.S. Cl. CPC B41J 13/28; B41J 13/0018; B41J 13/03

(57) ABSTRACT

An image forming apparatus includes a shutter member and a control member. The shutter member is provided along a transportation path for a sheet, and has an open state in which passage of the sheet is allowed or a closed state in which the passage of the sheet is not allowed. The shutter member enters the open state when subjected to a force of a specified magnitude from the sheet due to an end of the sheet being brought into contact with the shutter member. The control member enables control performed to change the specified magnitude.

### CROSS-REFERENCE TO RELATED PATENT APPLICATION

This application claims the benefit of Japanese Priority Patent Application JP 2024-216299 filed Dec. 11, 2024, the entire contents of which are incorporated herein by reference.

### FIELD OF THE DISCLOSURE

The present technology relates to an image forming apparatus that is applicable to, for example, a printer.

### BACKGROUND OF THE DISCLOSURE

Japanese Patent Application Laid-open No. 2017-122009 discloses a sheet transportation apparatus that can correct skewing of sheets. The sheet transportation apparatus includes a lock member with which sheets are brought into contact, and the lock member waits at a retraction position upon passage of a sheet. This makes it possible to enhance throughput.

### SUMMARY OF THE DISCLOSURE

In order to achieve the object described above, an image forming apparatus according to an embodiment of the present technology includes a shutter member and a control member.

The shutter member is provided along a transportation path for a sheet, and has an open state in which passage of the sheet is allowed or a closed state in which the passage of the sheet is not allowed. The shutter member enters the open state when subjected to a force of a specified magnitude from the sheet due to an end of the sheet being brought into contact with the shutter member.

The control member enables control performed to change the specified magnitude.

### BRIEF DESCRIPTION OF THE DRAWINGS

FIG. 1 schematically illustrates an example of a configuration of an image forming apparatus according to an embodiment of the present technology.

FIG. 2A schematically illustrates an example of a configuration of a shutter member.

FIG. 2B schematically illustrates the example of the configuration of the shutter member.

FIG. 3A schematically illustrates an example of a configuration of a control member.

FIG. 3B schematically illustrates the example of the configuration of the control member.

FIG. 4A is a perspective view illustrating an example of the configuration of the control member in detail.

FIG. 4B is a perspective view illustrating the example of the configuration of the control member in detail.

FIG. 5A is a side view illustrating an example of the configuration of the control member in detail.

FIG. 5B is a side view illustrating the example of the configuration of the control member in detail.

### DETAILED DESCRIPTION OF THE EXEMPLARY EMBODIMENTS

Hereinafter, an embodiment of the present disclosure will be described with reference to the drawings.

### Image Forming Apparatus

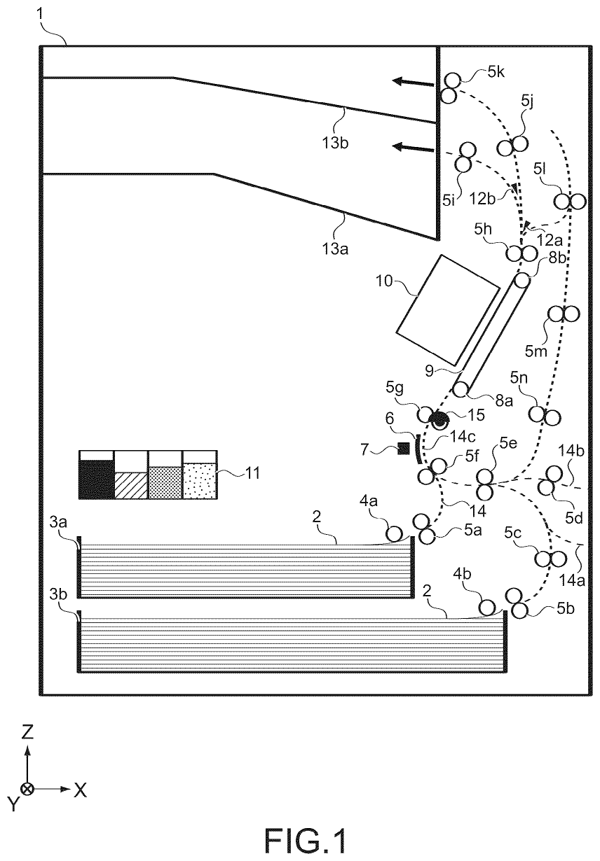

FIG. 1 schematically illustrates an example of a configuration of an image forming apparatus 1 according to an embodiment of the present technology.

FIG. 1 illustrates an interior of the image forming apparatus 1. The image forming apparatus 1 is a printer that forms a color image on paper 2 by ink jetting. The image forming apparatus 1 may be, for example, another type of printer, a fax machine, a copying machine, or a multifunctional device.

Here, an XYZ coordinate system is defined for the figures for convenience. It is assumed that, in the coordinate system, a positive side of a Y axis is a depth side in the figure, as viewed from a direction in which a positive side of a Z axis is an upper side in the figure and a positive side of an X axis is a right side in the figure (that is, the coordinate system is a right-handed coordinate system). In the present embodiment, the image forming apparatus 1 is arranged, as illustrated in FIG. 1, with a Z direction being an orthogonal direction (a gravity direction) and each of X and Y directions being a horizontal direction. Note that, when the present technology is applied, an orientation of the image forming apparatus 1 in use is not limited.

The image forming apparatus 1 includes sheet cassettes 3 (3a, 3b), pick rollers 4 (4a, 4b), roller pairs 5 (5a to 5n), a transportation guide 6, a sensor 7, pulleys 8 (8a, 8b), a transportation belt 9, a line head 10, an ink container 11, flaps 12 (12a , 12b), and discharge trays 13 (13a, 13b).

The sheet cassette 3 is a cassette that accommodates therein the paper 2. The paper 2 is a flat sheet cut to have a rectangular shape. In the present embodiment, a plurality of the pieces of paper 2 is placed inside of the sheet cassette 3 in parallel with the horizontal direction.

A specific shape of the paper 2 is not limited, and the shape may be changed properly to the extent that the present technology is feasible. In the present embodiment, the two sheet cassettes 3a and 3b are provided, and different types of the paper 2 are respectively accommodated in the sheet cassettes 3a and 3b. For example, plain paper or thin paper is accommodated in the sheet cassette 3a, and thick paper is accommodated in the sheet cassette 3b. Moreover, any types of sheets may be accommodated in the sheet cassette 3. Further, only one sheet cassette 3, or three or more sheet cassettes 3 may be used.

The paper 2 corresponds to an embodiment of a sheet according to the present technology.

The pick roller 4a is rotated by a drive source such as a motor to feed a piece of uppermost paper 2 in the sheet cassette 3a to the transportation path 14. FIG. 1 illustrates the transportation path 14 using a dashed line. Note that the transportation path 14 illustrated in FIG. 1 is merely an example, and a specific route of the transportation path 14 is not limited.

The roller pair 5 includes two rollers, and, for example, one of the two rollers is rotated by a drive source so that the paper 2 is sandwiched between the two rollers to be fed. A space between the roller pairs 5 corresponds to a portion of the transportation path 14 through which the paper 2 passes. Thus, it can also be said that the roller pairs 5 are arranged along the transportation path 14. A specific number of the roller pairs 5 and a specific position of the roller pair 5 are not limited.

A side of the transportation path 14 that the paper 2 passes on first is hereinafter referred to as an upstream side, and a side of the transportation path 14 that the paper 2 passes on afterward is hereinafter referred to as a downstream side. As illustrated in FIG. 1, the paper 2 fed by the pick roller 4a passes through the roller pair 5a first, and is transported along the transportation path 14 to pass through the roller pair 5f situated on the downstream side. Note that a transportation guide used to cause the paper 2 to proceed along the transportation path 14 is properly provided between the roller pairs 5a and 5f, although an illustration thereof is omitted. The same applies to a space between the other roller pairs 5.

The pick roller 4b is rotated by the drive source to feed a piece of uppermost paper 2 in the sheet cassette 3b to the transportation path 14. The paper 2 passes through the roller pairs 5b, 5c, 5e, and 5f in this order.

Further, in the present embodiment, the paper 2 fed from an extension unit (not illustrated) is transported along a transportation path 14a to join in a portion of the transportation path 14 that is situated between the roller pairs 5c and 5e. Further, the paper 2 fed from a manual feeding tray is transported along a transportation path 14b, and passes through the roller pair 5d to arrive at the roller pair 5e. The extension unit, the manual feeding tray, the transportation paths 14a and 14b described above, and the roller pair 5d described above do not necessarily have to be provided.

A transportation path 14c situated between the roller pairs 5f and 5g is a curved portion. The transportation guide 6 has a curved shape substantially similar to a curved shape of the transportation path 14c, and is provided along the transportation path 14c. In the present embodiment, the transportation guide 6 is provided to the left of the transportation path 14c (on a negative side in the X direction).

The sensor 7 is provided to the left of the transportation guide 6. In other words, the sensor 7 is provided on an opposite side of the transportation guide 6 from the transportation path 14c. When the paper 2 passes through the transportation path 14c, the sensor 7 detects a position of an end of the paper 2.

A shutter member 15 is connected to the roller pair 5g. A configuration of the shutter member 15 is described in detail later.

The pulleys 8, the transportation belt 9, and the line head 10 are provided between the roller pairs 5g and 5h. The transportation belt 9 is an endless belt, and is held by being put along the pulleys 8a and 8b. The transportation belt 9 is also rotated by one of or both of the pulleys 8a and 8b being rotated by a drive source. A surface (an upper-left face) of the transportation belt 9 corresponds to a portion of the transportation path 14, and the paper 2 is also moved from the upstream side to the downstream side due to rotation of the transportation belt 9. Note that, in order to fix the paper 2 to the surface of the transportation belt 9, a hole is provided to the surface of the transportation belt 9, and the paper 2 sticks to the transportation belt 9 due to a negative pressure applied through the hole.

The line head 10 is provided to face the surface of the transportation belt 9, and ejects an ink of black, cyan, magenta, or yellow onto the paper 2 at a specified timing. This results in forming a color image on the paper 2. The ink ejected from the line head 10 is supplied from the ink container 11 through, for example, a tube (not illustrated).

The line head 10 corresponds to an embodiment of an image forming section that is arranged downstream of the shutter member 15 in the transportation path 14.

After the paper 2 passes through the roller pair 5h, the flap 12a causes the paper 2 to be transported into a left branch when double-sided printing is not performed. Next, the flap 12b causes the paper 2 to be transported in a direction of one of the roller pairs 5i and 5j. The paper 2 transported to the roller pair 5i is discharged into the discharge tray 13a. The paper 2 transported to the roller pair 5j passes through the roller pair 5k to be discharged into the discharge tray 13b. In this example, two discharge trays 13 are provided. This makes it possible to, for example, separate discharge destinations of printed matter for respective persons in charge of performing printing. On the other hand, only a single discharge tray 13 may be provided.

After the paper 2 passes through the roller pair 5h, the flap 12a causes the paper 2 to be transported into a right branch when double-sided printing is performed. After the paper 2 passes through the roller pair 5l, the paper 2 is switched back to pass through the roller pairs 5m and 5n, and arrives at the roller pair 5e. Thereafter, the line head 10 forms an image on an unprinted side of the paper 2 in a similar manner, and the paper 2 is discharged into the discharge tray 13a or 13b.

Moreover, a specific configuration of the image forming apparatus 1 is not limited. For example, a drying mechanism that dries an ink deposited on the paper 2, or an inspection apparatus that inspects a formed image may be provided.

### Shutter Member

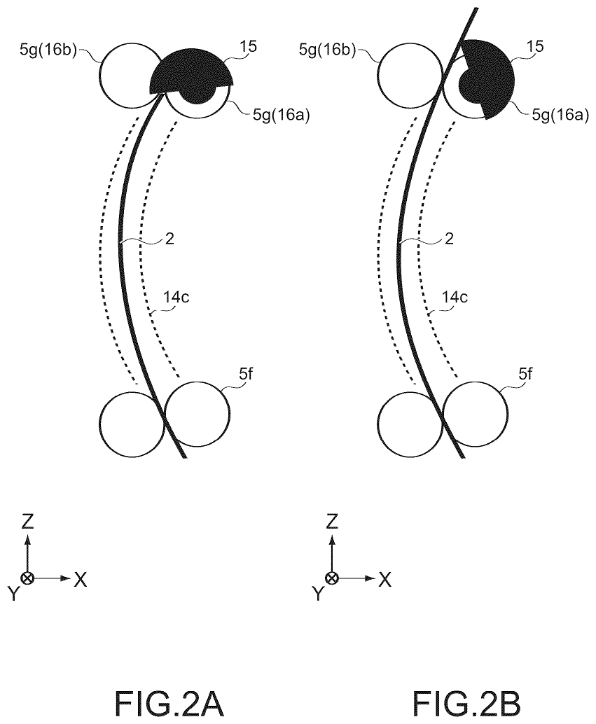

FIGS. 2A and 2B schematically illustrate an example of the configuration of the shutter member 15.

FIGS. 2A and 2B illustrate the roller pairs 5f and 5g and shutter member 15 illustrated in FIG. 1. Further, the transportation path 14c between the roller pairs 5f and 5g is illustrated using dashed lines, and the paper 2 transported along the transportation path 14c is also illustrated. Note that illustrations of the transportation guide 6 and the sensor 7 are omitted. Here, a roller of the roller pair 5g that is situated on the right is referred to as a roller 16a, and a roller of the roller pair 5g that is situated on the left is referred to as a roller 16b for convenience.

The configuration of the shutter member 15 is described in detail later. As illustrated in FIGS. 2A and 2B, the shutter member 15 is connected to the roller 16a on the right. The roller 16a is provided along the transportation path 14c. Thus, it can be said that the shutter member 15 is also provided along the transportation path 14c.

The shutter member 15 is configured to be rotatable about the same rotational axis as the roller 16a. Further, the rotation enables the shutter member 15 to be in an open state or in a closed state. The open state is a state illustrated in FIG. 2B, and is a state in which the shutter member 15 is rotated clockwise to not close a portion that corresponds to the transportation path 14 of the paper 2. In this state, the paper 2 can pass through the roller pair 5g and is transported downstream without the shutter member 15 preventing the paper 2 from proceeding.

The closed state is a state illustrated in FIG. 2A, where the shutter member 15 is rotated counterclockwise to close the portion corresponding to the transportation path 14 of the paper 2. In this state, an end of the paper 2 (the end on the downstream side) is brought into contact with the shutter member 15. Thus, the paper 2 is not allowed to pass through the roller pair 5g and is not transported downstream of the roller pair 5g.

Here, the shutter member 15 is biased with a force of a specified magnitude such that the shutter member 15 is in the closed state without being subjected to some kind of force from the paper 2. In other words, the shutter member 15 does not enter the open state spontaneously when the paper 2 is not brought into contact with the shutter member 15.

On the other hand, when the end of the paper 2 is brought into contact with the shutter member 15, as illustrated in FIG. 2B, the shutter member 15 is subjected to a force, from the end of the paper 2, that corresponds to a transportation force. On the other hand, the paper 2 is subjected to the transportation force and subjected to drag from the shutter member 15. Thus, the paper 2 is gradually bent with these forces.

If the bending of the paper 2 becomes greater, the force applied by the end of the paper 2 to the shutter member 15 becomes greater due to paper stiffness of the paper 2. Note that a magnitude of the force is also dependent on the type of the paper 2. For example, when the paper 2 is rigid paper or thick paper, the paper 2 has a high paper stiffness. This results in a strong force being applied to the shutter member 15. On the other hand, when the paper 2 is soft paper or thin paper, the paper 2 has a low paper stiffness. This results in a weak force being applied to the shutter member 15.

When the force applied by the paper 2 to the shutter member 15 reaches a force of a specified magnitude that is greater than a biasing force necessary to cause the shutter member 15 to be in the closed state, the shutter member 15 is rotated clockwise to enter the open state illustrated in FIG. 2B. As a result, the paper 2 passes through the roller pair 5g to be transported downstream.

### Control Member

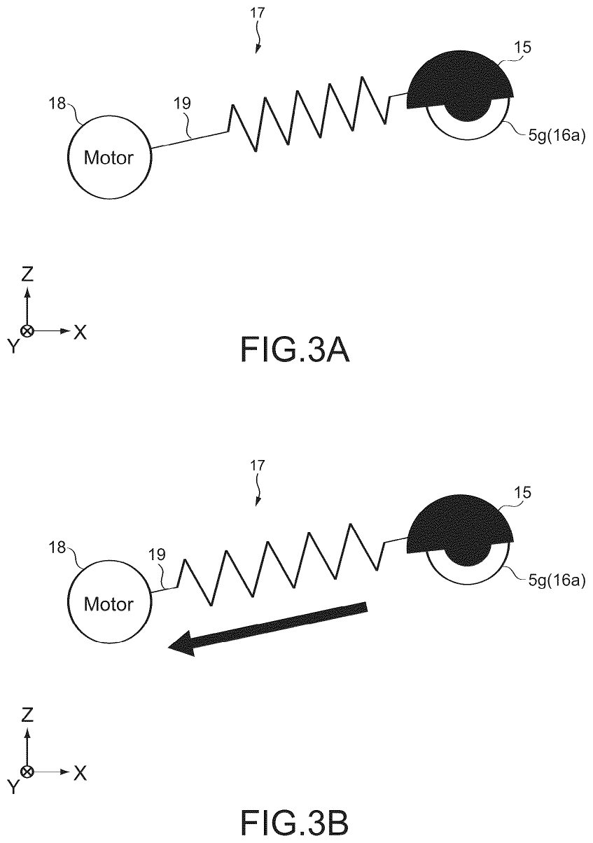

FIGS. 3A and 3B schematically illustrate an example of a configuration of a control member 17.

FIGS. 3A and 3B illustrate the shutter member 15 and the roller 16a in addition to the control member 17. In the present embodiment, the control member 17 performs control to change a specified magnitude of a force with which the shutter member 15 enters the open state. In other words, control to change the biasing force necessary to cause the shutter member 15 to be in the closed state, is performed.

The control member 17 includes a motor 18 and a spring 19. One of ends of the spring 19 is connected to the motor 18, and another of the ends is connected to a left portion of the shutter member 15. Note that FIGS. 3A and 3B are merely schematic diagrams, and a specific position that is situated on the shutter member 15 and to which the spring 19 is connected is not limited. Further, actually, a mechanism that includes a rack and a pinion and to which the motor 18 and the spring 19 are connected is arranged. These will be described later.

The motor 18 corresponds to an embodiment of a drive source according to the present technology.

In both of the states respectively illustrated in FIGS. 3A and 3B, an end of the shutter member 15 is pulled to the left due to an elastic force of the spring 19 to maintain the closed state when the shutter member 15 is not in contact with the paper 2. In other words, the spring 19 biases the shutter member 15 with the elastic force such that the shutter member is in the closed state.

The spring 19 can be extended and compressed by the motor 18 being driven. In FIG. 3A, the spring 19 is in a compressed state due to the motor 18 being driven. In this state, the elastic force of the spring 19 is weak. Thus, the biasing force for the shutter member 15 is also weak. On the other hand, in FIG. 3B, the spring 19 is in an extended state due to the motor 18 being driven. In this state, the elastic force of the spring 19 is strong. Thus, the biasing force for the shutter member 15 is also strong (an arrow illustrated in FIG. 3B).

As described above, the biasing force can be changed by the motor 18 being driven. In other words, control to change a specified magnitude of a force with which the shutter member 15 enters the open state can be performed.

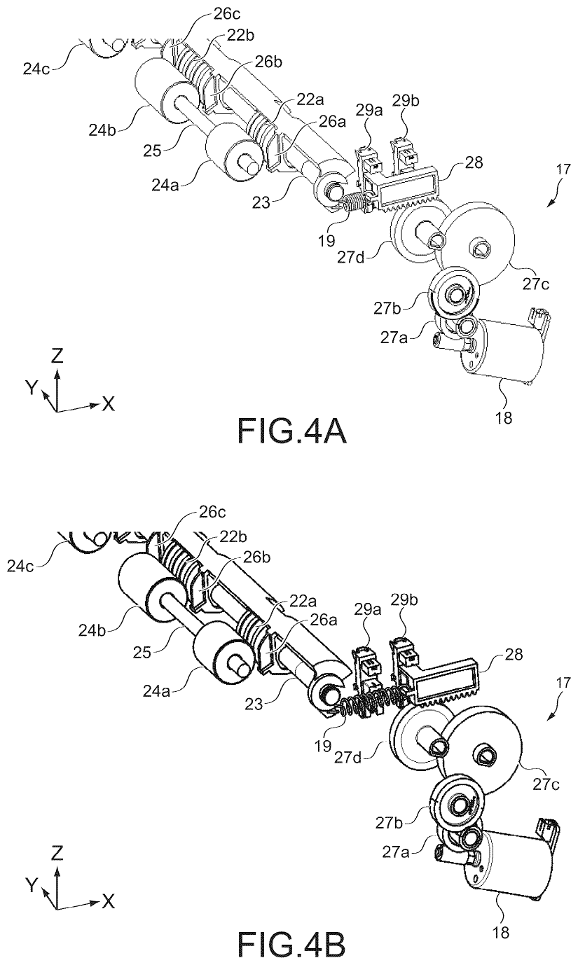

FIGS. 4A and 4B are perspective views illustrating an example of the configuration of the control member 17 in detail.

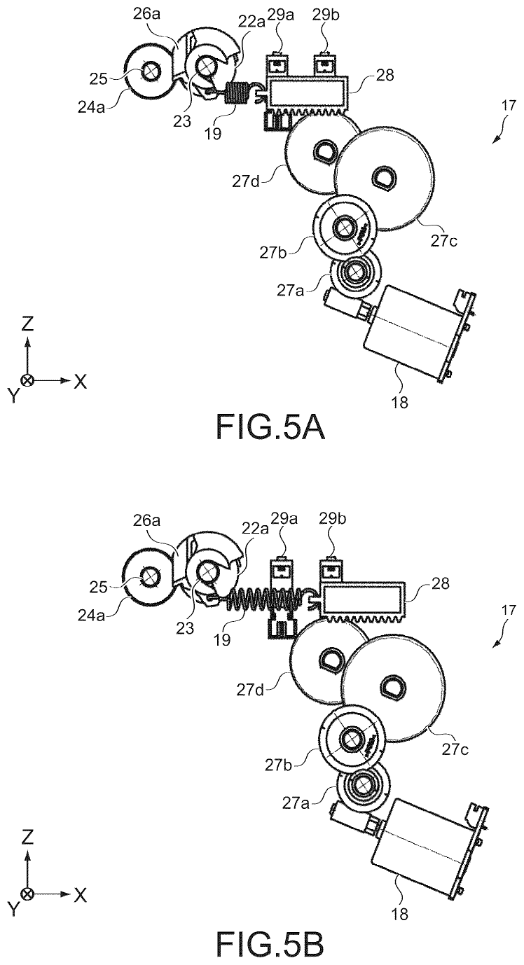

FIGS. 5A and 5B are side views illustrating an example of the configuration of the control member 17 in detail.

In FIGS. 4A and 5A, the spring 19 is compressed, and the shutter member 15 is biased weakly. In FIGS. 4B and 5B, the spring 19 is extended, and the shutter member 15 is biased strongly. Further, in all of FIGS. 4A, 4B, 5A, and 5B, the shutter member 15 is in the closed state.

In this example, the roller 16a includes a plurality of rollers 22 (22a, 22b, . . . ), and a shared axial member 23 passes through center portions of the plurality of rollers 22. Further, the roller 16b includes a plurality of rollers 24 (24a, 24b, 24c, . . . ). In this example, a shared axial member 25 passes through center portions of, for example, the rollers 24a and 24b. When the axial member 23 is rotated due to operation of a drive source (not illustrated), all of the rollers 22 are rotated integrally. Then, the roller 24 in contact with the roller 22 is rotated. As a result, the paper 2 is sandwiched between the rollers 22 and 24 to be transported.

The shutter member 15 is arranged to cover the axial member 23, but the shutter member 15 is configured to not be rotated together with rotation of the axial member 23. The shutter member 15 includes contact members 26 ahead of and behind the rollers 22 (on a negative side of and on the positive side of the Y axis). FIGS. 4A and 4B illustrate a contact member 26a situated ahead of the roller 22a, a contact member 26b situated ahead of the roller 22b, and a contact member 26c situated behind the roller 22b. A lower end of the contact member 26 is a portion with which the paper 2 is actually brought into contact.

In addition to the motor 18 and the spring 19, the control member 17 includes pinions 27 (27a to 27d), a rack 28, and stoppers 29 (29a, 29b). In this example, a gear is provided to an end portion of the motor 18. The pinion 27 is a twin stage gear obtained by adding a small gear and a large gear. A large gear of the pinion 27a engages with the gear provided to the end portion of the motor 18, a large gear of the pinion 27b engages with a small gear of the pinion 27a, a large gear of the pinion 27c engages with a small gear of the pinion 27b, and a large gear of the pinion 27d engages with a small gear of the pinion 27c.

The rack 28 is a plate-shaped member, and a teeth surface that engages with the large gear of the pinion 27d is provided to a lower portion of the rack 28. The right end of the spring 19 is connected to a left end of the rack 28, and the left end of the spring 19 is connected to a lower portion on a front side of the shutter member 15. As a result, the shutter member 15 is rotated counterclockwise due to the elastic force of the spring 19 and biased to be in the closed state.

When the motor 18 is driven, the pinions 27a to 27d are rotated together, and the rack 28 is moved from side to side. As a result, the spring 19 is extended and compressed, and there is a change in the elastic force. In other words, the motor 18, the pinions 27, and the rack 28 serve as an extension-and-compression mechanism that transfers a force produced by the motor 18 to the spring 19 to extend and compress the spring 19 and to change the elastic force.

The stopper 29 is a member that controls excessive movement of the rack 28. Specifically, a convex portion is provided on a depth side of the rack 28 (on the positive side of the Y axis), and when the convex portion is brought into contact with the stopper 29a on the left, the rack 28 is not moved to the left anymore, and thus the spring 19 is also not compressed anymore. Further, when the convex portion is brought into contact with the stopper 29b on the right, the rack 28 is not moved to the right anymore, and thus the spring 19 is also not extended anymore. The provision of the stoppers 29 makes it possible to prevent other members from being damaged due to the spring 19 being extended and compressed excessively.

The method for connecting the motor 18 and the spring 19 using gears is not limited, and the type of gear, the number of gears, and arrangement of gears that are different from those in this example may be adopted. Further, the method for converting a drive force of the motor 18 into extension and compression of the spring 19 is also not limited, and any mechanisms may be adopted. Furthermore, the method for changing the biasing force for the shutter member 15 is also not limited to the method performed using the motor 18 and the spring 19, and any methods may be used. A specific configuration of the shutter member 15 is also not limited, and the shutter member 15 may be provided separately from the roller pair 5g if the present technology is feasible.

### Correction of Oblique Movement

A method for correcting oblique movement of the paper 2 according to the present technology is described. An example in which the paper 2 is transported in a state of being parallel to a Y-Z plane illustrated in FIGS. 4A, 4B, 5A, and 5B and in a state of being rotated slightly counterclockwise, as viewed from the negative side in the X direction, is described. In this case, first, a portion of the end of the paper 2 is brought into contact with the contact member 26a. Note that the biasing force for the shutter member 15 is set to be greater than the transportation force for the paper 2. Thus, the shutter member 15 does not enter the open state at this point.

Next, the end of the paper 2 is brought into contact with the other contact members 26b, 26c, . . . successively. Further, a portion that is included in the paper 2 and situated near the end of the paper 2 is curved to form a loop. Generally, the loop has a largest size near the contact member 26a, and has larger sizes near 26b, 26c, . . . in this order. Due to a series of movement for the contact and the loop formation, the end of the paper 2 is made parallel to the Y direction, and oblique movement of the paper 2 is corrected.

When the paper 2 forms a loop, a pressing force that tries to cause the shutter member 15 to enter the open state is generated due to paper stiffness of the paper 2. When a sum of the pressing force and the transportation force exceeds the biasing force for the shutter member 15, the shutter member 15 enters the open state, and the paper 2 passes through the roller pair 5g.

Here, when, for example, the paper 2 is weak paper, such as thin paper, that has a low paper stiffness and when the biasing force for the shutter member 15 is made too strong, the end of the paper 2 is damaged due to the biasing force. On the other hand, when the paper 2 is strong paper, such as thick paper, that has a high paper stiffness and when the biasing force is made too weak, oblique movement is not corrected sufficiently due to lack of sufficient biasing force. In order to solve such issues, the present technology makes it possible to change the biasing fore of the shutter member 15 according to the type of the paper 2.

Specifically, first, the type of the paper 2 is determined using a plurality of sensors provided on an input side of the shutter member 15. Alternatively, the type of the paper 2 may be determined by acquiring printing settings input by a user. Next, correspondence of the type of the paper 2 to a degree of extension and compression of the spring 19 is referred to, and the motor 18 is driven such that an appropriate degree of extension and compression is achieved. This makes it possible to set the biasing force suitable for the type of the paper 2.

As described above, in the image forming apparatus 1 according to the present embodiment, the shutter member 15 entering the opening state when subjected to a force of a specified magnitude from the paper 2 due to the end of the paper 2 being brought into contact with the shutter member 15, is arranged, the open state in which passage of the paper 2 is allowed. Further, control to change the specified magnitude is performed. This makes it possible to correct oblique movement stably regardless of the type of the paper 2.

Further, in the present technology, the spring 19 biasing the shutter member 15 with the elastic force such that the shutter member 15 is in the closed state, is provided. This makes it possible to adjust the biasing force with a high degree of accuracy.

Furthermore, in the present technology, an extension-and-compression mechanism is provided that changes the elastic force by the spring 19 being extended and compressed, and the extension-and-compression mechanism includes the motor 18, the pinions 27, and the rack 28. This makes it possible to convert more rotation performed by the motor 18 into less movement of the rack 28, and thus to adjust a degree of extension and compression of the spring 19 in detail.

Moreover, in the present technology, the roller pair 5 is arranged in the transportation path 14, where the paper 2 is sandwiched between rollers of the roller pair 5 to be fed. The shutter member 15 is connected to the roller pair 5g, and the shutter member 15 is in the open state such that the paper 2 is allowed to pass through the roller pair 5g or is in the closed state such that the paper 2 is not allowed to pass through the roller pair 5g. This makes it possible to transport the paper 2 stably.

Further, in the present technology, the line head 10 being arranged downstream of the shutter member 15 and forming an image on the paper 2, is provided. As a result, an image is formed in a state in which oblique movement of the paper 2 has been corrected. This makes it possible to prevent malfunctioning such as forming an image obliquely.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus, comprising:
a shutter member that is provided along a transportation path for a sheet, the shutter member having an open state in which passage of the sheet is allowed or a closed state in which the passage of the sheet is not allowed, the shutter member entering the open state when subjected to a force of a specified magnitude from the sheet due to an end of the sheet being brought into contact with the shutter member; and
a control member that enables control performed to change the specified magnitude.

2. The image forming apparatus according to claim 1, wherein
the control member includes a spring that biases the shutter member with an elastic force such that the shutter member is in the closed state.

3. The image forming apparatus according to claim 2, wherein
the control member includes an extension-and-compression mechanism that changes the elastic force by the spring being extended and compressed.

4. The image forming apparatus according to claim 3, wherein
the extension-and-compression mechanism includes a drive source that extends and compresses the spring.

5. The image forming apparatus according to claim 4, wherein
the extension-and-compression mechanism includes at least one of a rack or a pinion, the rack and pinion transferring a force produced by the drive source to the spring.

6. The image forming apparatus according to claim 1, further comprising
a roller pair that is arranged in the transportation path, the sheet being sandwiched between rollers of the roller pair to be fed, wherein
the shutter member is connected to the roller pair,
the open state is a state in which the sheet is allowed to pass through the roller pair, and
the closed state is a state in which the sheet is not allowed to pass through the roller pair.

7. The image forming apparatus according to claim 1, further comprising
an image forming section that is arranged downstream of the shutter member in the transportation path, the image forming section forming an image on the sheet.
